(19) United States
(12) Patent Application Publication
(10) Pub. No.: US 2002/0128849 A1
(43) Pub. Date: Sep. 12, 2002

(54) Business method for reserving intellectual property rights in materials or articles claimed in patents

(76) Inventor: Kenneth S. Wheelock, Pittsfield, MA (US)

Correspondence Address: Kenneth S. Wheelock, 25 Juliana Drive, Pittsfield, MA, 01201, US

(21) Appl. No.: 09/777,329

(22) Filed: Feb. 5, 2001

Related U.S. Application Data
(63) Continuation-in-part of application No. 09/758,719, filed on Jan. 11, 2001.

(51) Int. Cl. G06F 17/60

(52) U.S. Cl. 705/1

(57) ABSTRACT

A business method comprising the steps of offering to transfer patented subject matter by means of an instrument being a contract license or lease wherein the term of the instrument expires prior to or concurrently with the patent wherein the instrument by its terms reserves some or all of the intellectual property rights in the patented subject matter to the patentee (or assignee) and prohibits use of the transferred patented subject matter in any fashion that develops, generates or invents new intellectual property.

### CROSS-REFERENCE TO RELATED APPLICATIONS

This Application is a Continuation-in-Part Application of U.S. Ser. No. 09/758,719 filed Jan. 11, 2001.

### FIELD OF THE INVENTION

The invention relates primarily to a method of doing business. More particularly the present invention relates to a method of doing business involving materials or articles of manufacture. Said materials comprise components or materials that are protected by one or more claims of at least one valid and enforceable patent wherein said method comprises licensing said components or materials as a means of transferring possession.

### BACKGROUND OF THE INVENTION

Equipment leases now extend to consumers as well as businessmen. Materials leases are not unknown. Materials leases have frequently occurred in the context of the refining and petrochemicals industry where catalytic materials that are comprised of valuable precious metals, e.g. Pt, Pd, Ag, Ru, Rh, Os, Ir, and Au among others by way of example, are leased to the refiner or chemical processor. In such instances the manufacturer makes use of the catalyst to accomplish desired chemical conversions and when the catalyst is spent, i.e. used up or inactive, the material is returned to the catalyst owner for reclaiming of the precious metal and re-working of the catalyst. Such an arrangement frequently has several business advantages because precious metal catalysts are capital assets. The lessee who can be a manufacturer, refiner or chemical processor that leases the catalyst pays a fee that is proportional in some measure to the business benefit conferred upon the lessee. When the leased catalyst is returned to the lessor, it is assayed and the lessee is responsible to the lessor for any shortage in valuable precious metal.

As presently constituted, current legal doctrine cuts off control of a patented material by the patentee or assignee after the first sale of the patented material. Subsequent sales of the patented invention after the first sale are not subject to any control by the inventor. This is the so-called first sale doctrine. Thus when title to new compositions of matter passes from the inventor to a purchaser, the purchaser is free to use the new composition of matter in any way that is legally permissible without any further indemnification to the inventor. One such permissible use is that the purchaser may use the new composition of matter in making further inventions.

In contradistinction to patent law, copyright law preserves rights in derivative works to the copyright holder. Because a patent grant is the right to exclude others from making using or selling, so-called improvement patents may issue grounded in a new composition of matter. It should be noted that the inventor of a new composition of matter can prevent use of the new improvement by reason of rights conferred in the original patent grant. However, the rights conferred by the original patent grant do not confer any rights in subsequent improvements to the invention of the original new composition of matter unless the original inventor is also an inventor of the improvement. This occurs despite the fact that but for the new composition of matter subsequent improvement patents grounded in the new composition of matter would not have been possible.

### SUMMARY OF THE INVENTION

The present invention provides for a method of doing business comprising the transfer of goods from a transferor to a transferee wherein the goods are transferred one or more times by means of an instrument selected from the group consisting of contracts, leases or licenses, said instrument having terms wherein the instrument and all subsequent instruments transferring said goods reserve some or all of the intellectual property rights in the goods to the transferor and wherein the transferee is prohibited from using the goods to develop any new intellectual property by the terms of the instrument.

Another embodiment of the method of the present invention provides for a method of doing business comprising the transfer of goods from a licensor to a licensee wherein the goods are transferred by means of a license having terms wherein the license reserves some or all of the intellectual property rights in the goods to the licensor and wherein the licensee is prohibited from using the goods to develop any new intellectual property by the terms of the license.

The invention of the present method further provides for a method of doing business comprising the transfer of goods from a licensor to a licensee wherein the goods are transferred one or more times by means of a license having terms wherein the license and all intervening licenses and sub-licenses reserve some or all of the intellectual property rights in the goods to the licensor and wherein the licensee, assignee or sub-licensee is prohibited from using the goods to develop any new intellectual property by the terms of the license wherein the last transfer is a transfer of goods at retail.

More particularly, the invention of the present method provides for a method of doing business comprising the transfer of goods from a licensor to a licensee wherein the goods, subject to a least one claim of at least one valid and enforceable patent, are transferred by means of a license having terms wherein the license reserves some or all of the intellectual property rights in the goods to the licensor and wherein the licensee is prohibited from using the goods to develop any new intellectual property by the terms of the license.

Further, the invention of the present method further provides for a method of doing business comprising the transfer of goods from a licensor or lessor to a licensee or lessee wherein the goods, preferably subject to a least one claim of at least one valid and enforceable patent, are transferred one or more times by means of a license or lease having terms wherein the license or lease and all intervening licenses and sub-licenses or all intervening leases and sub-leases reserve some or all of the intellectual property rights in the goods to the licensor or lessor and wherein the licensee, assignee, sub-licensee or sub-lessee (collectively sub-transferee) is prohibited from using the goods to develop any new intellectual property by the terms of the license wherein the last transfer is a transfer of goods at retail.

### DETAILED DESCRIPTION OF THE INVENTION

In addition to its other commonly accepted meanings, as used herein the word “some” means “at least one.” As used herein the phrase “intellectual property rights” are rights to patents, designs, trade secrets, copyrights, databases, know-how and all other intellectual property rights, in each case whether registered or unregistered and including applications for the grant of any of the foregoing and all rights or forms of protection having equivalent or similar effect to any of the foregoing which may subsist anywhere in the world in that intangible property exemplified by the foregoing list but not limited thereto. When used together in the phrase “some or all of the intellectual property rights” these words also mean at the least a percentage interest or undivided fractional interest in at least one intellectual property right, in addition to the other meanings herein defined. In addition, these definitions are inclusive of the ordinary meanings of the terms as they are customarily used and defined.

Rights in real property are rights that are severable, i.e. rights that can be separated from each other. The owner of a plot of land, who is said to own the property in fee simple absolute, has several rights. Some of the owner's rights are: 1) the right to use the property, 2) the right to convey or transfer the property, 3) the right to destroy the property, 4) the right to exclude others from the property, 5) the right to the fruits and profits of the land, and 6) the right to possess the land. The owner may permit another person to use one of these rights but not all of them together. A real property lease is an example where the leaseholder or lessee is granted some or all of these rights for a specified period of time but at the end of the lease, the property reverts to the original owner, the licensor. A real property lease is an example where the leaseholder or lessee is granted some or all of these rights for a specified period of time but at the end of the license or lease, the property reverts to the original owner, the licensor or lessor. Similar rules of law apply to rights in personal property. Both real and personal property may be leased or licensed.

When real or personal property is sold, all of the rights associated with the property are transferred to the buyer from the seller. When a lease is sold, all of the rights in the lease are transferred to the buyer. When a license is sold, all of the rights in the license may or may not be are transferred to the buyer; if fewer rights are transferred to the buyer the license is a sub-license. However, because it is not possible to sell, lease or license what is not owned, rights reserved by the owner in granting a license remain with the owner even though the license or lease is sold. The sale of a lease is usually referred to as an assignment of the lease, the leaseholder or licensee acting as an assignor of the lease, assigns the lease to the assignee. The sale of a license is usually referred to as an assignment of the license, the licensee acting as an assignor of the license, assigns the license to the assignee who becomes the licensee (or sub-licensee). This type of transaction may continue through several assignments. As long as all the terms of the lease or license are assigned, the assignee stands in the shoes of the lessee or licensee as far as the relationship to the owner, lessor or licensor is concerned.

Just as the owner or licensor can reserve rights, when a license is transferred the licensee or assignor may reserve some rights and the new license is subordinate to the first license and is in effect a sub-license, the purchaser of a sub license is a sub-licensor. Sub-leases or sub-licenses may be assigned as above or they may be further sub-leased or sub-licensed. In any event, rights reserved by the owner (licensor or lessor) remain under the control of the owner, regardless of who is in possession.

In the United States, letters patent (hereafter patent) are a constitutionally mandated personal property having a fixed term and having the right to exclude others from making, using or selling the patented invention within the United States. Patents may be bought and sold, they may be licensed and they may be leased. Materials and articles covered by the claims of active and enforceable patents may be bought and sold, licensed or leased.

The present invention constitutes a method of doing business wherein new compositions of matter or articles of manufacture covered by the claims of valid and enforceable patents are transferred by means of an instrument selected from the group consisting of contracts, leases and licenses wherein the transferee is prohibited from using the goods to develop new intellectual property by the terms of the instrument. Such a transfer where some of the rights are reserved is not a sale of all right title and interest (herafter “sale”). Because there is no sale of the patented goods, there is no operation of the first sale doctrine. Instead of making, using or selling the patented composition, the inventor, patentee or assignee (hereafter patentee) generally licenses or leases the composition or article of manufacture covered by the claims of one or more valid and enforceable patents (in of two particular embodiments). The license or lease of the present invention confers almost all of the rights associated with a transfer of ownership that would otherwise be a complete transfer of all right, title and interest but for the reservation of rights in intellectual property which at its very least includes a prohibition on experimentation to develop new intellectual property. Thus, some or all of the rights to the intellectual property embodied in the patented invention are reserved to the patentee along with the right to use the claimed invention in any experimental fashion that might possibly result in the creation of additional new intellectual property (as used in this application the terms “inventor,” “patentee” and “assignee of the patent” are used more or less interchangeably to denote that legal entity possessing all right, title and interest in and to the patented invention). Furthermore, the creation of additional new intellectual property by the transferee (licensee, assignee of the license, sub-licensee or sub-transferee) of the instrument is prohibited by the terms of the instruemnt. Such additional intellectual property includes but is not limited to patentable subject matter, copyrightable subject matter and trade secret matter among others previously recited. The instrument transfers the right to possess and use but reserves to the patentee (or assignee of the patent) some or all of the intellectual property rights along with the right to use the patented composition to develop new intellectual property rights. If the instrument is grounded in more than one patent, at the expiration of the latest to expire patent in which the instrument is grounded, the instrument expires. But for the new claimed composition or article of manufacture, new intellectual property, i.e. additional inventions or trade secrets would not be possible. Inventions utilizing the claimed composition or article of manufacture would consequently be obtained in violation of the instrument. The instruments of the present invention preserves a patentee's interest in derivative improvement inventions for the term of the instrument. This also furthers an important public policy interest in stimulating development of new and useful inventions and arts because the reservation of rights by an inventor, patentee or assignee utilized by the licenses (or leases) of the present invention redirects the efforts of others in designing around the patented intellectual property that is protected by the instruments, i.e. contracts, licenses or leases of the present invention. The instruments of the present invention may be granted for a term less than that of the patent or patents under which the instrument is granted.

If the instrument is a license, whether the license is a business to business transaction or a business to consumer transaction, if the unilateral contract formation provisions of the following exemplified licenses (or leases) are to have a higher likelihood of being enforceable against a purchaser of the license, a letter or other notice preceding shipment of the goods should be sent to the prospective recipient of the goods. This letter should place the prospective licensee, assignee of the license, or sub-licensee on notice concerning the terms of the license and the unilateral contract formation terms of the license as regards the joint development agreement therein recited.

Unlike a business to business transaction where the types of materials licenses (or leases) of the method of the present invention are contemplated and are negotiated, consumer transactions at retail do not provide opportunity for such give and take in negotiating to obtain the benefit of the bargain. In retail transactions the consumer must be given fair notice that the goods are not being purchased but are instead being leased and that the lease imposes certain restrictions on use, specifically the reservation of intellectual property rights and a prohibition on exercising the right to experiment with the licensed goods to create new intellectual property rights. In order to provide fair notice to the transferee (consumer) of goods encumbered with such a reservation of intellectual property rights, the notice must be prominently displayed on the outside packaging of the goods being transferred so that the prospective transferee has or would have had the opportunity to read and accept the terms of the notice prior to consummating the transaction.

One embodiment of such a notice on the outside of the packaging would deal with materials or articles covered by the claims of valid and enforceable patents and could read as follows:

“NOTICE—Materials (or Article) License—Intellectual Property Rights Reserved and Notice of Contract Formation—the materials (or article) contained in this packaging are (or is) the subject of one of more United States (or other jurisdiction) patents (list of relevant patent numbers). The price on this package reflects the cost to license the materials (or article) within from the patentee or assignee (hereinafter licensor) for a period of time not to exceed the latest relevant expiring patent grant. The licensor is the patentee or assignee of the United States (or otherjurisdiction) patents listed above and is leasing the materials or article herein contained to licensee in consideration of the price of transfer subject to the following terms and conditions:

1) all rights to use and enjoy the materials or articles contained herein are being transferred to the licensee by the licensor (patentee or assignee of the patent) including the right to assign this license or sub-license to the materials or articles contained herein with the exception of:

a) all rights in the intellectual property embodied by the materials or articles being licensed and

b) the right to use the materials or article or the intellectual property embodied by the materials or article in any fashion or manner that creates new intellectual property rights where such intellectual property rights are not vested in the licensor;

2) licensee agrees and promises that when acting as an assignor or sub-licensor that assignor or sub-licensor will advise and require all subsequent assignees or sub-licensees to publish this notice and bind these terms to subsequent transferees (hereinafter sub-transferee) who by accepting this material or article become sub-transferees; and

3) all subsequent transferees and successors in interest to this license as sub-transferees are bound by these limitations whether the material or article herein contained is transferred for consideration or by act of donation.

4) Licensor's remedy for breach of this license by licensee, sub-licensee or sub-transferee may include at licensor's option revocation of this license and/or repossession of the licensed goods, contract damages, damages for patent infringement and all other available remedies at law or in equity or

5) where licensee, assignee of the license, sub-licensee or sub-transferee develops new intellectual property in breach of this license, in consideration of the exercise of the right to experiment with the licensed goods and thereby develop new intellectual property licensee, assignee of the license, sub-licensee or sub-transferee agrees that such exercise shall be an acceptance by performance of a contract for joint development of the new intellectual property where both licensor and licensee, assignee of the license, sub-licensee or sub-transferee own an undivided interest in the new intellectual property and licensee, assignee of the license, sub-licensee or sub-transferee hereby agrees to assign to licensor a one-half undivided interest in any intellectual property developed thereby and to make all reasonable efforts to perfect such intellectual property rights and to execute all documents necessary to establish such undivided right, title and interest in licensor.

This license shall be governed by the law of the state of (select state) without giving effect to its choice of law provisions. At the expiration of the last to expire relevant patent grant, this license expires. No variation in the terms of this license is permitted unless agreed to in writing by licensor. Licensor may be contacted at (licensor's address).” This particular language is probably more suitable to a composition or article that is not a composite, i.e. that does not contain any unpatented subject matter.

Composite materials comprising the claimed invention and materials that are standard items of commerce could be transferred in the business method of the present invention to subsequent users by a hybrid transaction constituting both a sale and license. Such a hybrid transaction would consist of a sale of the ordinary items of commerce comprising the composite or manufactured article and a license covering the claimed composition as a component in the composite or manufactured article transferring ordinary use to the licensee but reserving the right to develop additional intellectual property rights to the licensor. In each transfer and subsequent transfer thereafter, each transferee and subsequent transferee would be required to be put on notice that the material being transferred was being transferred in a hybrid sale and license transaction wherein the portion of the material subject to the license was under a reservation of intellectual property rights.

Alternatively composite materials could be licensed in their entirety. In this case, in each transfer and subsequent transfer thereafter, each transferee and subsequent transferee would be required to be put on notice that the material being transferred was being transferred in a license transaction wherein certain material subject to the license was under a reservation of intellectual property rights.

When a composition or article is not exclusively composed of patented subject matter the license notice on the outside of the packaging might read as follows:

“NOTICE—Materials (or Article) License—Intellectual Property Rights Reserved and Notice of Contract Formation—the materials (or article) contained in this packaging comprise materials or articles that are (or is) the subject of one of more United States (or other jurisdiction) patents (list of relevant patent numbers). The price on this package reflects the cost to license the materials (or article) within from the patentee or assignee of the patent (hereinafter licensor) for a period of time not to exceed the latest relevant expiring patent grant. The licensor is the patentee or assignee of the United States (or other jurisdiction) patents listed above and is leasing the materials or article herein contained to licensee in consideration of the price of transfer subject to the following terms and conditions:

1) all rights to use and enjoy the materials or articles contained herein are being transferred to the licensee by the licensor (patentee or assignee of the patent) including the right to assign this license or sub-license to the materials or articles contained herein with the exception of:

a) all rights in the intellectual property embodied by the materials or articles being Licensed and

b) the right to use the materials or article or the intellectual property embodied by the materials or article in any fashion or manner that creates new intellectual property rights where such intellectual property rights are not vested in the licensor;

2) licensee agrees and promises that when acting as an assignor or sub-licensor that assignor or sub-licenser will advise and require all subsequent assignees or sub-licensees to publish this notice and bind these terms to subsequent transferees (hereinafter sub-transferee) who by accepting this material or article become sub-transferees; and

3) all subsequent transferees and successors in interest to this license as sub-transferees are bound by these limitations whether the material or article herein contained is transferred for consideration or by act of donation.

4) Licensor's remedy for breach of this license by licensee, sub-licensee or sub-transferee may include at licensor's option revocation of this license and/or repossession of the licensed goods, contract damages, damages for patent infringement and all other available remedies at law or in equity or

5) where licensee, assignee of the license, sub-licensee or sub-transferee develops new intellectual property in breach of this license, in consideration of the exercise of the right to experiment with the licensed goods and thereby develop new intellectual property licensee, assignee of the license, sub-licensee or sub-transferee agrees that such exercise shall be an acceptance by performance of a contract for joint development of the new intellectual property where both licensor and licensee, assignee of the license, sub-licensee or sub-transferee own an undivided interest in the new intellectual property and licensee, assignee of the license, sub-licensee or sub-transferee hereby agrees to assign to licensor a one-half undivided interest in any intellectual property developed thereby and to make all reasonable efforts to perfect such intellectual property rights and to execute all documents necessary to establish such undivided right, title and interest in licensor.

This license shall be governed by the law of the state of (select state) without giving effect to its choice of law provisions. At the expiration of the last to expire relevant patent grant, this license expires. No variation in the terms of this license is permitted unless agreed to in writing by licensor. Licensor may be contacted at (licensor's address).”

Other forms of notice and reservation of intellectual property rights are contemplated by this disclosure and may be drafted by any competent attorney properly licensed to practice law. In making transfers of goods where intellectual property rights are reserved as above, the provisions of the Uniform Commercial Code governing Sales and Commercial Licenses in the relevant jurisdictions should be considered in order to avoid having the reservation of intellectual property rights voided by so-called form battles.

In the case of business to business transactions such licenses (or leases) reserving intellectual property rights will most likely be more complicated and extensive documents than the brief forms previously recited as examples of notice for consumers conducting transactions at retail. However, in both cases, commercial licenses (or leases) and consumer licenses (or leases), the reservation of intellectual property rights and the limitation on the right to experiment with the patented material will be a component of the license as well as the requirement that sub-licensees are bound by the conditions of the license. In the foregoing examples of retail notice the joint development partition of rights use was set by way of example at a one-half undivided interest in any new intellectual property developed. This proportion of a one-half undivided interest is by way of example in terms of the division of ownership in the new invention. Depending upon the ease of experimentation and other factors, the partitioning of rights might devolve to as much as nine-tenths (or 90%) undivided interest or more for truly seminal inventions where in other cases such as marginal inventions it might devolve to as little as one-tenth (or 10%) undivided interest or less.

Broadly stated and conceived the present invention relates to a method of doing business where patented compositions or articles (goods) are not sold but instead are licensed or leased wherein the license or lease reserves to the licensor or lessor (the patentee or assignee of the invention) any or all of intellectual property rights embodied in the goods, including the right to experiment or modify the goods resulting in the creation of new patentable subject matter. The license or lease extends to all licensees, assignees, lessees, sub-licensees or sub-lessees (or sub-transferees) by reason of granting to the licensee or lessee and each subsequent assignee, lessee, sub-licensee or sub-lessee the right to act as assignor or sub-licensor provided all the conditions of the license or lease are required of each subsequent assignee, lessee, sub-licensee or sub-lessee (sub-transferee). Such a condition maintains privity of license and/or privity of contract. The draft licenses (or leases) above recite consideration for exercise of the right to perform experimentation as an acceptance by performance of a unilateral contract that creates a joint development between licensor and licensee (or successors in interest to the licensee) where the consideration for exercising the right to perform experimentation, albeit in breach of the license, is an undivided interest in the new intellectual property rights created by the experimentation.

The licenses (or leases) created by the business method of the present invention are for a definite term fixed by the term of the patent grant under which the license is granted, If the license is grounded in more than one patent grant, at the expiration of the last to expire patent, the license expires. The licenses or leases of the present invention may be for a term less than the term of the patent or patents under which the license or lease is granted.

In offering to license goods at retail, by publishing a notice on the packaging containing the goods in a size that can be read by the potential transferee (licensee or sub-licensee), as demonstrated in the section of this application denoted “Examples,” the potential licensee is put on actual notice and can make an informed decision as to whether to accept the terms of the license and tender consideration for transfer of possession subject to the reservation of intellectual property rights. This type of license, as one embodiment of this business method, might be seen as a counterpart to a so-called shrink wrap license. Unlike shrink-wrap licenses that are only a license to use software, i.e. a single use, the license(s) of the present invention prohibit(s) certain uses while freely allowing others. Further, the licenses (or leases) are grounded in the claims of one or more valid patents unlike shrink-wrap licenses which while they may grounded in copyright law do not devolve to a joint development effort that shares rights as contemplated by the present licenses (or leases) if new intellectual property is developed. The terms of the instant licenses (or leases) contractually require a grant back of rights in any intellectual property developed by licensee, assignee of the license or any sub-licensees to the patentee (or assignee of the patent) and this is one major distinction between a shrink-wrap license and the licenses (or leases) of the present invention. The grant back provisions in case of breach in the licenses (or leases) of the present invention is more akin to the situation in real property law where an improvement which is a fixture (such as a building) to real property leased under a ground lease inures to the benefit of the freeholder at the expiration of the lease. The licenses (or leases) of the present invention do not interfere with either the statutes or regulations governing inventorship or the requirements of patent law.

While shrink-wrap licenses have recently been the subject of litigation they have been found to be enforceable. This is because shrink-wrap licenses are not unconscionable when the license notice affords an opportunity to avoid the license by avoiding purchase or by not tendering consideration. According to many courts, such licenses do not offend any provisions of Article 2 of the Uniform Commercial Code. Additionally the concept of such licenses has been expanded from computer software to computer hardware. Parties to a contract, license or lease may exercise their right to breach the instrument. However, the exercise of the right to breach can be stipulated to be an acceptance by performance of a unilateral contract where the terms of the unilateral contract are clearly spelled out prior to executing the governing instrument, which itself can be governed by performance, such as purchase or tender of the consideration for transfer.

Absent negotiation between commercially sophisticated parties, the licenses (or leases) of the present method when used at retail require notice of the terms to be prominently displayed. In the event that a patent issues on the present application, notice that intellectual property rights have been reserved under the business method of the instant patent application (see tables 1 and 2 below) may suffice to trigger the exemplified license notices previously recited. Such licenses have been found to be enforceable.

Reviewing the model drafts of the various articles of the Uniform Commercial Code, there are no prohibitions against materials licenses (or leases) and no comments regarding a partitioning of rights in a license or lease, particularly as it relates to intellectual property rights and a required grant back of such rights as a preferred remedy in the event of breach of the license or lease.

The licenses (or leases) of the present invention as exemplified as an embodiment of the present invention have a forum selection clause. In selecting a forum, jurisdictions that have found shrink-wrap licenses are preferred, e.g. Illinois (Seventh Circuit). Since website forum selection clauses in Internet site access agreements have been found to be enforceable, there is no reason to suspect such forum selection clauses would not be enforceable.

### EXAMPLES

Some of the business methods that are embodiments of the method of the present invention are as follows:

I. A business as licensor to another business license of a material or materials (or article or articles) covered by one or more claims of at least one active, valid and enforceable patent wherein the license reserves some or all of the intellectual property rights in the licensed material(s) and prohibits those uses of the licensed material that develops new intellectual property. The license is freely assignable or may be sub-licensed subject to the restrictions of the license. If licensee, assignee of the license, sub-licensee or sub-transferee develops new intellectual property such development is an acceptance by performance of a joint development contract where licensor has an equity participation in and rights to the new intellectual property.

II. A business as assignor to another business assigning a license of a material or materials (or article or articles) covered by one or more claims of at least one active, valid and enforceable patent wherein the license reserves some or all of the intellectual property rights in the license material(s) and prohibits those uses of the licensed material that develops new intellectual property. The license is freely assignable or may be sub-licensed subject to the restrictions of the license. If licensee, assignee of the license, sub-licensee or sub-transferee develops new intellectual property such development is an acceptance by performance of a joint development contract where licensor has an equity participation in and rights to the new intellectual property.

III. A business as assignor or sub-licensor to another business as sub-licensee sub-license of a license of a material or materials (or article or articles) covered by one or more claims of at least one active, valid and enforceable patent wherein the license reserves some or all of the intellectual property rights in the license material(s) and prohibits those uses of the licensed material that develops new intellectual property. The license is freely assignable or may be sub-licensed subject to the restrictions of the license. If licensee, assignee of the license, sub-licensee or sub-transferee develops new intellectual property such development is an acceptance by performance of a joint development contract where licensor has an equity participation in and rights to the new intellectual property.

IV. A business as licensor to a retail consumer as licensee assigning a license of a material or materials (or article or articles) covered by one or more claims of at least one active, valid and enforceable patent wherein the license reserves some or all of the intellectual property rights in the license material(s) and prohibits those uses of the licensed material that develops new intellectual property. The license is freely assignable or may be sub-licensed subject to the restrictions of the license. If licensee, assignee of the license, sub-licensee or sub-transferee develops new intellectual property such development is an acceptance by performance of a joint development contract where licensor has an equity participation in and rights to the new intellectual property.

V. A business as licensor, assignor or sub-licensor to a retail consumer as sub-licensee of a license of a material or materials (or article or articles) covered by one or more claims of at least one active, valid and enforceable patent wherein the license reserves some or all of the intellectual property rights in the license material(s) and prohibits those uses of the licensed material that develops new intellectual property. The license is freely assignable or may be sub-licensed subject to the restrictions of the license. If licensee, assignee of the license, sub-licensee or sub-transferee develops new intellectual property such development is an acceptance by performance of a joint development contract where licensor has an equity participation in and rights to the new intellectual property.

VI. A business as licensor or assignee acting as sub-licensor of a license to another business as sub-licensee, sub-licenses the license of a material or materials (or article or articles) covered by one or more claims of at least one active, valid and enforceable patent wherein the license reserves some or all of the intellectual property rights in the licensed material(s) and prohibits those uses of the licensed material that develops new intellectual property. The license is freely assignable or may be sub-licensed subject to the restrictions of the license. If licensee, assignee of the license, sub-licensee or sub-transferee develops new intellectual property such development is an acceptance by performance of a joint development contract where licensor has an equity participation in and rights to the new intellectual property.

VII. A business as sub-licensor as assignor of a license to another business as sub-licensee of the license of a material or materials (or article or articles) covered by one or more claims of at least one active, valid and enforceable patent wherein the license reserves some or all of the intellectual property rights in the license material(s) and prohibits those uses of the licensed material that develops new intellectual property. The license is freely assignable or may be sub-licensed subject to the restrictions of the license. The agreed upon remedy for breach of the condition not to develop new intellectual property using the licensed material is an equity participation in the rights of the new intellectual property.

As broadly contemplated by the present invention, the inventor, patentee or assignee is the original licensor or lessor while the licensee or lessee may be another business entity or a consumer at retail. Dependent upon intermediate manufacturing steps and legal relationships, the licensee or lessee may assign, sub-license or sub-lease as appropriate in which case the entity receiving the licensed goods would be the assignee, sub-licensee or sub-lessee of the goods. This chain of licenses (or leases), assignments and sub-licenses (or leases) could involve many potential parties all of whom are bound by the original license that reserves intellectual property rights and prohibits use of the goods in any fashion that develops new intellectual property. The purpose of this type of license is to preserve to the creator of the intellectual property the right to indemnification for subsequent developments building upon the creativity of the creator of the licensed goods. When the patent in which the license is grounded expires, the license expires.

A most compelling rationale for this approach is to consider the currently hypothetical example of the inventor of a room temperature superconducting material. Such an invention is truly seminal and others could build on it to develop equipment, methods of making machines utilizing the superconductor, methods of making the superconductor, and improvements in each and every one of these general areas. By making and selling the material the inventor of the superconductor, who has made a truly monumental contribution looses all right to collaborate in the making of further inventions using his ground breaking invention. The licenses (or leases) of the present invention preserve those rights of collaboration and joint development and economically recognize and increase the reward for such seminal contributions to society.

In the event the licensed material is destroyed, either by accident or by design, breach of the license or lease reserving intellectual property rights is no longer possible. If the intended use of the material is pharmaceutical, the license terms can be amended to permit therapeutic consumption as a licensed activity under the terms of the license and still retain intellectual property rights in the conversion products produced as a consequence of consumption.

The exemplification and explanation of the foregoing is for purposes of illustrating the present invention as a method of doing business and is not to be construed as limiting the scope of the invention by way of example.

The text of the sample licenses (or leases) recited or exemplified in the detailed description of the present invention are sufficiently brief that they may be printed on the outside of commercial packaging. The following tables illustrate the approximate dimensions of a column of text reciting notice and the terms of the license.

TABLE 1
Column Lengths as a Function of Text Font Size -
3.0 inch Column Width

| | | Total Column |
|---|---|---|
| | | Length at |
| | | 3.0 inches |
| | Font Size | (7.62 cm) width |
| | (as defined by | (approximate |
| Text Section | Microsoft Word ®) | dimensions) |
| NOTICE | 18 | |
| Materials (or Article) | 14 | |
| License | | |
| Intellectual Property Rights | 12 | |
| Reserved . . . | | |
| materials . . . may be | 8 | 8.9 inches |
| contacted at (licensor's | | (22.61 cm) length |
| address). | | |
| materials . . . may be | 6 | 5.4 inches |
| contacted at (licensor's | | (13.72 cm) length |
| address). | | |

TABLE 2
Column Lengths as a Function of Text Font Size -
4.5 inch Column Width

| | | Total Column |
|---|---|---|
| | Font Size | Length at |
| | (as defined by | 4.5 inches |
| Text Section | Microsoft Word ®) | (11.43 cm) width |
| NOTICE | 18 | |
| Materials (or Article) | 14 | |
| License | | |
| Intellectual Property Rights | 12 | |
| Reserved . . . | | |
| materials . . . may be | 8 | 6.1 inches |
| contacted at (licensor's | | (15.49 cm) length |
| address). | | |
| materials . . . may be | 6 | 3.9 inches |
| contacted at (licensor's | | (10.0 cm) length |
| address). | | |

Having described the invention, that which is claimed is:

1. A method of doing business comprising the transfer of goods from a licensor to a licensee wherein the goods are transferred by means of a license having terms wherein the license reserves some or all of the intellectual property rights in the goods to the licensor and wherein the licensee is prohibited from using the goods to develop any new intellectual property by the terms of the license.

2. The method of claim 1 wherein the goods are claimed in one or more patents.

3. The method of claim 2 wherein the license may be assigned by the licensee to a first assignee.

4. The method of claim 3 wherein the license may be further assigned by the first assignee to a second assignee.

5. The method of claim 4 wherein the license may be further assigned by the first assignee to a second assignee.

6. The method of claim 5 wherein the goods are claimed in one patent.

7. The method of claim 6 wherein the license may be assigned by the licensee to a first assignee.

8. The method of claim 7 wherein the license may be further assigned by the first assignee to a second assignee.

9. The method of claim 2 wherein the goods are claimed in more than one patent.

10. The method of claim 9 wherein the license may be assigned by the licensee to a first assignee.

11. The method of claim 10 wherein the license may be further assigned by the first assignee to a second assignee.

12. The method of claim 2 wherein the term of the instrument expires prior to or concurrently with the term of the patents.

13. A method of doing business comprising the transfer of goods from a transferor to a transferee wherein the goods are transferred one or more times by means of an instrument selected from the group consisting of contracts, leases or licenses, said instrument having terms wherein the instrument and all subsequent instruments transferring said goods reserve some or all of the intellectual property rights in the goods to the transferor and wherein the transferee is prohibited from using the goods to develop any new intellectual property by the terms of the instrument.

14. The method of claim 13 wherein the goods are the subject of one or more claims of one or more patents.

15. The method of claim 14 wherein the instrument is a license.

16. The method of claim 15 wherein the license may be assigned.

17. The method of claim 14 wherein the instrument is a contract.

18. The method of claim 17 wherein the contract may be assigned.

19. The method of claim 14 wherein the instrument is a lease.

20. The method of claim 19 wherein the lease may be assigned.

21. The method of claim 16 wherein the license may be further assigned.

22. The method of claim 18 wherein the contract may be further assigned.

23. The method of claim 20 wherein the lease may be further assigned.

24. The method of claim 14 wherein the term of the instrument expires prior to or concurrently with the term of the patents.

25. A method of doing business comprising the transfer of goods from a transferor to a transferee wherein the goods are transferred one or more times by means of an instrument selected from the group consisting of contracts, leases or licenses said instrument having terms wherein the instrument and all intervening instruments reserve some or all of the intellectual property rights in the goods to the transferor and wherein the transferee or sub-transferee is prohibited from using the goods to develop any new intellectual property by the terms of the instrument wherein the last transfer is a transfer of goods at retail.
